(19) United States
(12) Patent Application Publication
(10) Pub. No.: US 2015/0210021 A1
(43) Pub. Date: Jul. 30, 2015

(54) DEEP-DRAWING PACKAGING MACHINE COMPRISING AN ULTRASONIC DEVICE

(71) Applicant: Multivac Sepp Haggenmüller GMBH & Co. KG, Wolfertschwenden (DE)

(72) Inventor: Reinhard Ruhland, Bad Gronenbach (DE)

(21) Appl. No.: 14/603,210

(22) Filed: Jan. 22, 2015

(30) Foreign Application Priority Data
Jan. 24, 2014 (DE) 102014201329.1

(51) Int. Cl. B29C 71/00; B65B 61/02; B29C 51/08; B65B 51/00

(52) U.S. Cl. CPC B29C 71/0063; B65B 51/00; B65B 61/02; B29C 51/082; B29K 2067/003

(57) ABSTRACT

The invention relates to a deep-drawing packaging machine comprising an ultrasonic device, and to a method for heating the foil at a predetermined breaking line by means of a sonotrode, so that a recrystallization of the foil takes place along the predetermined breaking line.

### CROSS-REFERENCE TO RELATED APPLICATIONS

This Application claims priority to German Patent Application Number 102014201329.1 filed Jan. 24, 2014, to Reinhard Ruhland, currently pending, the entire disclosure of which is incorporated herein by reference.

### FIELD OF THE INVENTION

The invention relates to a deep-drawing packaging machine and method for operating a deep-drawing packaging machine.

### BACKGROUND OF THE INVENTION

Various packagings are known in practice which are manufactured on deep-drawing packaging machines and comprise various opening aids. For example, one packaging is known from WO 2008/092200 which includes a predetermined breaking line allowing the packaging to be opened along this predetermined breaking line for accessing the contents therein. The material of the foil has a special structure at the predetermined breaking line, which may be a material weakening, for example.

To allow packagings of this type to be opened along a predetermined breaking line, brittle foils, formed of polystyrene (PS) for example, are used to enhance the breaking capacity. The drawback of PS, when used as packaging material, is the high material price as compared to, for example, polypropylene (PP), polyethylene terephthalate (PET) or amorphous polyethylene terephthalate (APET). PP, PET and APET are semicrystalline, less crystalline than PS, and the brittleness thereof is too low to be usable for an opening aid, such as a predetermined breaking line as outlined above.

Applications of ultrasonic devices for sealing and cutting foils on packaging machines are known from DE 102007021967 A1 and DE 102008035994 A1.

### SUMMARY OF THE INVENTION

It is one object of the present invention to improve a deep-drawing packaging machine to allow the production of packagings with a predetermined breaking line with the use of foils made of materials such as PP, PET or APET.

The deep-drawing packaging machine according to one embodiment of the present invention comprises a forming station for deforming a plastic foil, a sealing station and an ultrasonic device, wherein the ultrasonic device comprises a sonotrode. The deep-drawing packaging machine is characterized in that the ultrasonic device may be provided in the forming station or, in the production direction, downstream of the forming station and upstream of the sealing station, especially in order to produce an effective predetermined breaking line as an opening aid for the packaging after the forming process.

In one embodiment, the ultrasonic device is configured to locally heat the plastic foil deformed in the forming station and locally modify the crystalline structure of the foil, so as to thus allow the processing even of an inexpensive foil which, for example, cannot have a predetermined breaking line, or only an inferior one, without this modification, as the structure of the foil is not particularly suited therefor without the additional processing. The degree of crystallization of the foil can be locally increased during the ultrasonic treatment according to the invention.

The sonotrode of the ultrasonic device can heat the foil up to a temperature that results in a recrystallization of the foil. The recrystallization, namely, the increase of the degree of crystallization, at a predetermined breaking line may result in a local increase of the foil's brittleness and thus ensures that the packaging can be opened more easily by breaking the predetermined breaking line. The predetermined breaking line can thus represent a very good opening aid.

As used herein, the term “ultrasonic” implies oscillations with a frequency of at least 16 kHz.

The temperature in the foil, generated during the ultrasonic treatment, is preferably below the melting point of the foil.

In one embodiment, when heating the foil by means of the sonotrode, the temperature is at least about 40° C., preferably about 160° C., to allow a corresponding recrystallization of PP, PET or APET foils.

The sonotrode of the ultrasonic device can comprise a sound-radiating end surface which is congruent with the predetermined breaking line to be produced.

The ultrasonic device may comprise an upper part with a compressed air device, wherein the upper part is arranged above the foil so as to press the foil against the sound-radiating end surface of the sonotrode by means of compressed air. This represents an easy and inexpensive configuration, especially if several predetermined breaking lines are simultaneously produced on several sonotrodes, respectively, on an ultrasonic tool which is connected to a sonotrode and configured for several predetermined breaking lines. The compressed air, or an overpressure in the depression, can ensure a uniform pressure distribution of the foil on the sound-radiating end surface, and thus also a uniform recrystallization only along the predetermined breaking line.

In another embodiment, the ultrasonic device comprises an anvil and is adapted for clamping the foil between the radiating end surface of the sonotrode and the anvil. In this case, one sonotrode and one anvil cooperate to produce one predetermined breaking line.

A method according to one embodiment of the present invention for operating the deep drawing packaging machine comprising an ultrasonic device is characterized in that the ultrasonic device heats a foil along a predetermined breaking line so as to modify the crystalline structure of the foil along the predetermined breaking line.

The method may be particularly advantageous if the foil is formed of PP, PET or APET, as these foil materials are inexpensive and very well suited for packagings. Without the method according to the invention these foil materials have a brittleness that is not suited for a predetermined breaking point.

The sonotrode can heat the foil up to a temperature of at least about 140° C., preferably about 160° C., so as to modify the crystalline structure of the foil such that the brittleness at the predetermined breaking line of the packaging is increased.

The heating of the foil by means of the ultrasonic device can be carried out after the production of a depression in the foil. The contour of the predetermined breaking line may be formed after the deep-drawing forming process. The local heating only along the predetermined breaking line results in a suitable opening aid.

Other and further objects of the invention, together with the features of novelty appurtenant thereto, will appear in the course of the following description.

### DESCRIPTION OF THE SEVERAL VIEWS OF THE DRAWING

An advantageous exemplary embodiment of the invention will be explained in more detail below by means of a drawing. In the drawing:

FIG. 1 is a schematic side view of a deep-drawing packaging machine in accordance with one embodiment of the present invention;

FIG. 2 is a schematic side view of an ultrasonic device in accordance with one embodiment of the present invention;

FIG. 3a is a schematic sectional view of the ultrasonic device of FIG. 2, taken generally about line in the direction of the arrows, which is opposite to the production direction, illustrating the ultrasonic device in a waiting position;

FIG. 3b is a schematic sectional view of the ultrasonic device of FIG. 3a, illustrating the ultrasonic device in a working position;

FIG. 4a is a schematic sectional view of an ultrasonic device with an anvil in accordance with another embodiment of the present invention, illustrating the ultrasonic device in a waiting position; and

FIG. 4b is a schematic sectional view of the ultrasonic device of FIG. 4a, illustrating the ultrasonic device in a working position.

In the figures, like components are designated with like reference numbers.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

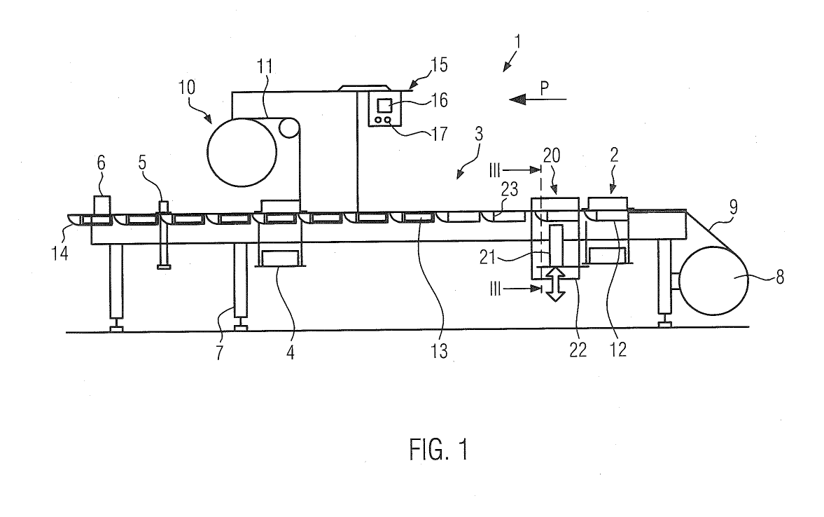

FIG. 1 shows a schematic lateral view of a deep-drawing packaging machine 1 according to one embodiment of the present invention. This deep-drawing packaging machine 1 may comprise a forming station 2, a loading section 3, a sealing station 4, a cross-cutting device 5 and a longitudinal cutter 6, which are arranged, in this order, on a machine frame 7 in a production direction P. A feed reel 8, from which a foil 9 is withdrawn, can be located at the front end of the machine frame 7. A material reservoir 10 may be provided in the area of the sealing station 4, from which an upper foil 11 is withdrawn. The deep-drawing packaging machine 1 may furthermore comprise a feeding device, not shown in more detail, which grasps the foil 9 and transports it per main work cycle in the production direction P. The feeding device may include, for example, transport chains or clamp chains arranged on either side.

In the embodiment shown, the forming station 2 is designed as a deep-drawing station in which depressions 12 are formed in the foil 9 by deep-drawing. The forming station 2 may be configured such that several depressions 12 are formed side by side in the direction perpendicular to the production direction P. In the loading section 3, the depressions 12 formed in the lower foil 9 are filled with product 13.

The sealing station 4 may define a chamber in which the depressions 12 are evacuated.

Prior to the sealing, the atmosphere in the depressions 12 can be replaced, for example by gas flushing with a replacement gas or a gas mixture.

The cross-cutting device 5 can be formed as a punch which severs the lower foil 9 and the upper foil 11 between adjacent depressions 12 in a direction transverse to the production direction P. In doing so, the cross-cutting device 5 works such that the foil 9 is not separated over the total width thereof. For example, the foil 9 may not be separated at least in an edge region. This allows for controlled transport by the feeding device.

In the embodiment shown, the longitudinal cutter 6 is configured as a knife arrangement by means of which the lower foil 9 and the upper foil 11 are cut through between adjacent depressions 12 and at the lateral edge of the lower foil 9, so that separated packagings 14 are provided downstream of the longitudinal cutter 6.

The deep-drawing packaging machine 1 may furthermore comprise a controller 15 which has the task of controlling and monitoring the processes executed in the deep-drawing packaging machine 1. A display apparatus 16 that includes operating elements 17 can serve to visualize the process operations in the deep-drawing packaging machine 1 for an operator.

Downstream from the forming station 2, an ultrasonic device 20 can be arranged, which may comprise a sonotrode 21 arranged underneath the foil 9. The sonotrode 21 can be lifted by a lifting device 22 up to the depressions 12 of foil 9 so as to contact the foil 9. The depression 12 includes a predetermined breaking line 23 formed in the forming station 2, which serves as an opening aid for the packaging 14. The predetermined breaking line 23 may be in the form of a notch or chamfer, for example.

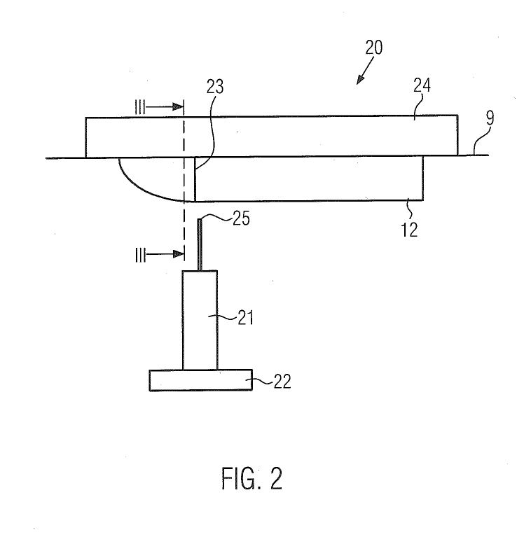

FIG. 2 shows the ultrasonic device 20 with sonotrode 21 and lifting device 22 in a waiting position. Above the depression 12 and the foil 9, an upper part 24 may be provided. The sonotrode 21 can have a sound-radiating end surface 25, the form of which may be congruent with the predetermined breaking line 23.

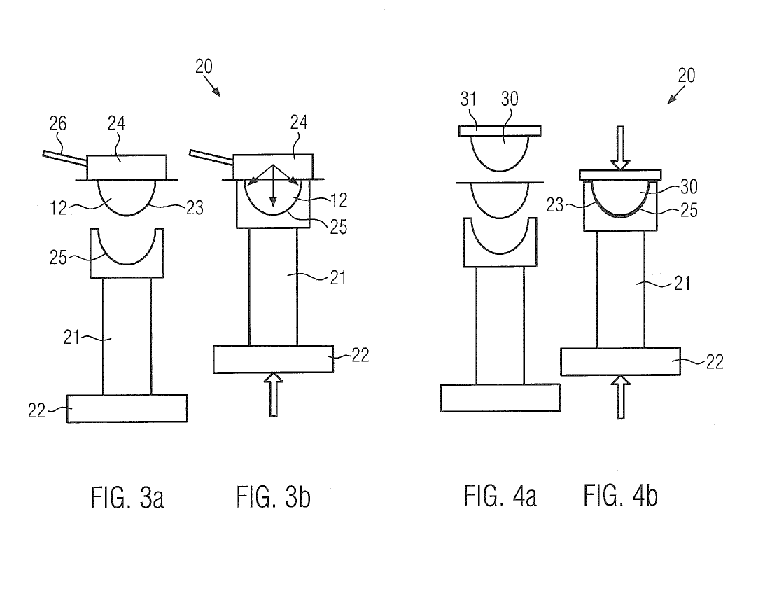

FIG. 3a shows a first embodiment of the ultrasonic device 20 with the lifting device 22 for the sonotrode 21 in the waiting position. The upper part 24 can include a medium line 26, for example, to allow compressed air to be introduced through the upper part 24 into the depression 12. In this illustration, the congruent form of the sound-radiating end surface 25 relative to the U-shaped predetermined breaking line 23 is well recognizable.

In FIG. 3b, the sonotrode 21 has been lifted by the lifting device 22 to the outside of the depression 12 and into the working position, and the sound-radiating end surface 25 rests against the U-shaped predetermined breaking line 23. To ensure that the foil 9 rests against the sound-radiating end surface 25 of the sonotrode, so that the foil 9 can be heated at the predetermined breaking line 23 during the ultrasonic treatment, compressed air may be supplied in the upper part 24 above the depression 12, which is depicted by arrows in FIG. 3b. The generated air pressure presses the foil 9 with a uniformly distributed force against the sound-radiating end surface 25 of the sonotrode 21. Through the oscillation generated by the sonotrode 21 and the friction of the foil 9 on the sound-radiating end surface 25, the corresponding heat input into the foil 9 takes place along the predetermined breaking line 23 so as to modify the crystalline structure of the foil 9 at the predetermined breaking line 23. The brittleness of the foil 9 is increased at the predetermined breaking line 23, and the breaking behavior for opening the packaging 14 is thus improved. The temperature generated in the foil 9 is below the melting temperature of the foil 9. Depending on the foil materials, the temperature may be between about 140° C. and about 160° C., so as to achieve a recrystallization.

FIG. 4a shows a modification of the ultrasonic device 20, comprising an anvil 30 with another lifting device 31 instead of an upper part 24. The lifting device 31 can move the anvil 30 from a waiting position into a working position downwards into the depression 12, as is shown in FIG. 4b. In the working position, the anvil 30 acts to hold the sonotrode 21 up in a lifted working position. The foil 9 can be clamped, along the predetermined breaking line 23, between the sound-radiating end surface 25 of the sonotrode 21 and the anvil 30 so as to introduce the heat input into the foil 9 for a recrystallization along the predetermined breaking line 23.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. Deep-drawing packaging machine comprising:
a forming station for deforming a plastic foil;
a sealing station; and
an ultrasonic device having a sonotrode, wherein the ultrasonic device is provided either in the forming station or in a location that is downstream of the forming station and upstream of the sealing station.

2. Deep-drawing packaging machine according to claim 1, wherein the ultrasonic device is configured to locally heat the foil deformed in the forming station so as to modify a crystalline structure of the foil.

3. Deep-drawing packaging machine according to claim 1, wherein the ultrasonic device is configured to heat the foil along a predetermined breaking line formed in the foil.

4. Deep-drawing packaging machine according to claim 2, wherein a temperature of the foil generated by the sonotrode is below the melting point of the foil.

5. Deep-drawing packaging machine according to claim 2, wherein a temperature of the foil generated by the sonotrode is at least 140° C.

6. Deep-drawing packaging machine according claim 3, wherein the sonotrode comprises a sound-radiating end surface that is congruent with the predetermined breaking line.

7. Deep-drawing packaging machine according claim 6, wherein the ultrasonic device comprises an upper part with a compressed air device, wherein the upper part is arranged above the foil so as to press the foil against the sound-radiating end surface of the sonotrode by means of compressed air.

8. Deep-drawing packaging machine according claim 6, wherein the ultrasonic device comprises an anvil to clamp the foil between the sound-radiating end surface of the sonotrode and the anvil.

9. Method for operating a deep drawing packaging machine comprising the steps of:
providing a forming station and an ultrasonic device;
deforming a foil in the forming station; and
heating the deformed foil by means of the ultrasonic device along a predetermined breaking line formed in the foil so as to modify a crystalline structure of the foil along the predetermined breaking line.

10. Method according to claim 9, wherein the foil is at least one of a polypropylene foil, a polyethylene terephthalate foil and an amorphous polyethylene terephthalate foil.

11. Method according to claim 9, wherein the ultrasonic device includes a sonotrode, and wherein the sonotrode heats the foil up to a temperature of at least 140° C.

12. Method according to claim 9, wherein the heating of the foil by means of the ultrasonic device is carried out after the production of a depression in the foil.
